(19) United States
(12) Patent Application Publication
(10) Pub. No.: US 2019/0217720 A1
(43) Pub. Date: Jul. 18, 2019

(54) HYBRID VEHICLE AUXILIARY BATTERY CHARGING METHOD AND ASSEMBLY

(71) Applicant: Ford Global Technologies, LLC, Dearborn, MI (US)

(72) Inventors: William David Treharne, Ypsilanti, MI (US); Mahmoud Abdelhamid, Canton, MI (US); Kevin James Rhodes, Dearborn, MI (US)

(21) Appl. No.: 15/869,788

(22) Filed: Jan. 12, 2018

(51) Int. Cl. B60L 11/18; B60W 50/14

(52) U.S. Cl. CPC B60L 11/1868; B60L 11/1866; B60L 11/1877; B60L 2250/16; B60L 11/1861; B60L 2260/54; B60W 2050/146; B60W 50/14

(57) ABSTRACT

An exemplary charging includes, among other things, transmitting an alert and receiving a command from a user in response to the alert. In response to the command, the method includes both running an engine to charge a traction battery and charging an auxiliary battery from the traction battery. An exemplary electrified vehicle assembly includes, among other things, a traction battery, an auxiliary battery, an engine, and a controller configured to cause the engine to run to charge the traction battery in response to a command received from a user. The controller is further configured to cause the traction battery to charge the auxiliary battery.

### TECHNICAL FIELD

This disclosure relates generally to charging an auxiliary battery in a hybrid vehicle. More particularly, this disclosure relates to running an engine to charge a traction battery, and charging the auxiliary battery from the traction battery.

### BACKGROUND

Generally, electrified vehicles differ from conventional motor vehicles because electrified vehicles are selectively driven using one or more battery-powered electric machines. Conventional motor vehicles, in contrast to electrified vehicles, are driven exclusively with an internal combustion engine. Electrified vehicles may use electric machines instead of, or in addition to, the internal combustion engine.

Some electrified vehicles, such as hybrid electric vehicles (HEVs), include a traction battery used to power one or more electric machines. The internal combustion engine can be driven to charge the traction battery. Such electrified vehicles may further include an auxiliary battery that can power, among other things, low-voltage loads of the vehicle. The auxiliary battery may power the low-voltage loads when the electrified vehicle is keyed off.

### SUMMARY

A charging method according to an exemplary aspect of the present disclosure includes, among other things, transmitting an alert and receiving a command from a user in response to the alert. In response to the command, the method both runs an engine to charge a traction battery and charges an auxiliary battery from the traction battery.

A further non-limiting embodiment of the foregoing method includes transmitting the alert in response to a charge level of the traction battery being below a threshold level.

In a further non-limiting embodiment of any of the foregoing methods, the threshold level is a charge level sufficient to charge the auxiliary battery.

A further non-limiting embodiment of any of the foregoing methods includes transmitting the alert in response to a charge level of the auxiliary battery being below a threshold level.

A further non-limiting embodiment of any of the foregoing methods includes a user-selected mode of the vehicle. The transmitting can occur when the user-selected mode is activated. The transmitting is blocked from occurring when the user-selected mode is deactivated.

In a further non-limiting embodiment of any of the foregoing methods, the alert is sent to a device remote from a vehicle having the engine.

In a further non-limiting embodiment of any of the foregoing methods, the command is received from the device remote from the vehicle.

In a further non-limiting embodiment of any of the foregoing methods, the command is received from a device remote from a vehicle having the engine.

In a further non-limiting embodiment of any of the foregoing methods, the alert is an in-vehicle alert.

In a further non-limiting embodiment of any of the foregoing methods, the in-vehicle alert is a visual alert displayed within the vehicle.

In a further non-limiting embodiment of any of the foregoing methods, the alert is transmitted at a completion of a drive cycle before the user has exited a passenger cabin of the vehicle.

In a further non-limiting embodiment of any of the foregoing methods, at least some of the charging of the auxiliary battery occurs while running the engine to charge the traction battery.

A further non-limiting embodiment of any of the foregoing methods includes, after running the engine to charge the traction battery, stopping the engine, and then starting the charging of the auxiliary battery from the traction battery.

An electrified vehicle assembly according to an exemplary aspect of the present disclosure includes, among other things, a traction battery, an auxiliary battery, an engine, and a controller configured to cause the engine to run to charge the traction battery in response to a command received from a user. The controller is further configured to cause the traction battery to charge the auxiliary battery.

In a further non-limiting embodiment of the foregoing assembly, the controller is configured cause the traction battery to charge the auxiliary battery after stopping the engine.

In a further non-limiting embodiment of any of the foregoing assemblies, the controller is configured to initiate a transmission of an alert in response to a charge level of the auxiliary battery falling below an auxiliary battery threshold charge level. The command that is received is in response to the alert.

In a further non-limiting embodiment of any of the foregoing assemblies, the controller is configured to initiate a transmission of an alert in response to a charge level of the traction battery falling below a traction battery threshold charge. The command that is received is in response to the alert.

In a further non-limiting embodiment of any of the foregoing assemblies, the command is received from a device remote from the vehicle.

In a further non-limiting embodiment of any of the foregoing assemblies, the command is received from an interface within a passenger cabin of the vehicle at the conclusion of a drive cycle.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### DESCRIPTION OF THE FIGURES

The various features and advantages of the disclosed examples will become apparent to those skilled in the art from the detailed description. The figures that accompany the detailed description can be briefly described as follows:

FIG. 1 illustrates a schematic view of a powertrain of an electrified vehicle.

FIG. 2 illustrates a highly schematic view of selected portions of an electrified vehicle incorporating the powertrain of FIG. 1, an auxiliary battery, and a device that is remote from the electrified vehicle.

FIG. 3 illustrates a plot of a voltage of the auxiliary battery from FIG. 2 verses a state of charge of the auxiliary battery.

FIG. 4 illustrates an example of the device remote from the vehicle.

FIG. 5 illustrates the flow of an example method of charging the auxiliary battery of FIG. 2 from the traction battery of FIG. 2 according to an exemplary embodiment.

FIG. 6 illustrates a flow of a method of charging the auxiliary battery of FIG. 2 from the traction battery of FIG. 2 according to another exemplary embodiment.

### DETAILED DESCRIPTION

This disclosure details methods and assemblies that charge an auxiliary battery of an electrified vehicle with a traction battery.

In particular, an alert can be provided to a user. In response to the alert, the user commands the electrified vehicle to, at an appropriate time, start an internal combustion engine to charge the traction battery. The traction battery can then be used to charge the accessory battery, even after the internal combustion engine is shut down. Among other things, this can ensure that a state of charge (SOC) of the auxiliary battery is maintained at an adequate level while reducing an operating time of the internal combustion engine.

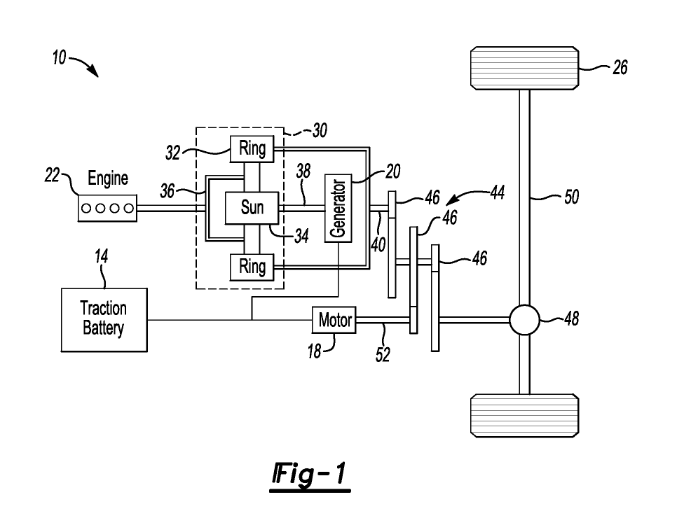

FIG. 1 schematically illustrates a powertrain 10 for an electrified vehicle, which is a hybrid electric vehicle (HEV) in this example. Although depicted as an HEV, it should be understood that the concepts described herein are not limited to HEVs and could extend to other types of electrified vehicle, including, but not limited to, plug-in hybrid electric vehicles (PHEVs), battery electric vehicles (BEVs), full hybrid electric vehicle (FHEVs), etc.

The powertrain 10 includes a traction battery 14, a motor 18, a generator 20, and an internal combustion engine 22. The motor 18 and generator 20 are types of electric machines. The motor 18 and generator 20 may be separate or may have the form of a combined motor-generator.

In this embodiment, the powertrain 10 is a power-split powertrain system that employs a first drive system and a second drive system. The first and second drive systems generate torque to drive one or more sets of vehicle drive wheels 26 of the electrified vehicle. The first drive system includes a combination of the engine 22 and the generator 20. The second drive system includes at least the motor 18, the generator 20, and the traction battery 14. The motor 18 and the generator 20 are portions of an electric drive system of the powertrain 10.

The engine 22, which is an internal combustion engine in this example, and the generator 20 may be connected through a power transfer unit 30, such as a planetary gear set. Of course, other types of power transfer units, including other gear sets and transmissions, could be used to connect the engine 22 to the generator 20. In one non-limiting embodiment, the power transfer unit 30 is a planetary gear set that includes a ring gear 32, a sun gear 34, and a carrier assembly 36.

The generator 20 can be driven by engine 22 through the power transfer unit 30 to convert kinetic energy to electrical energy. The generator 20 can alternatively function as a motor to convert electrical energy into kinetic energy, thereby outputting torque to a shaft 38 connected to the power transfer unit 30. Because the generator 20 is operatively connected to the engine 22, the speed of the engine 22 can be controlled by the generator 20.

The ring gear 32 of the power transfer unit 30 can be connected to a shaft 40, which is connected to vehicle drive wheels 26 through a second power transfer unit 44. The second power transfer unit 44 may include a gear set having a plurality of gears 46. Other power transfer units may also be suitable.

The gears 46 transfer torque from the engine 22 to a differential 48 to ultimately provide traction to the vehicle drive wheels 26. The differential 48 may include a plurality of gears that enable the transfer of torque to the vehicle drive wheels 26. In this example, the second power transfer unit 44 is mechanically coupled to an axle 50 through the differential 48 to distribute torque to the vehicle drive wheels 26.

The motor 18 can also be employed to drive the vehicle drive wheels 26 by outputting torque to a shaft 52 that is also connected to the second power transfer unit 44. In one embodiment, the motor 18 and the generator 20 cooperate as part of a regenerative braking system in which both the motor 18 and the generator 20 can be employed as motors to output torque. For example, the motor 18 and the generator 20 can each output electrical power to the traction battery 14.

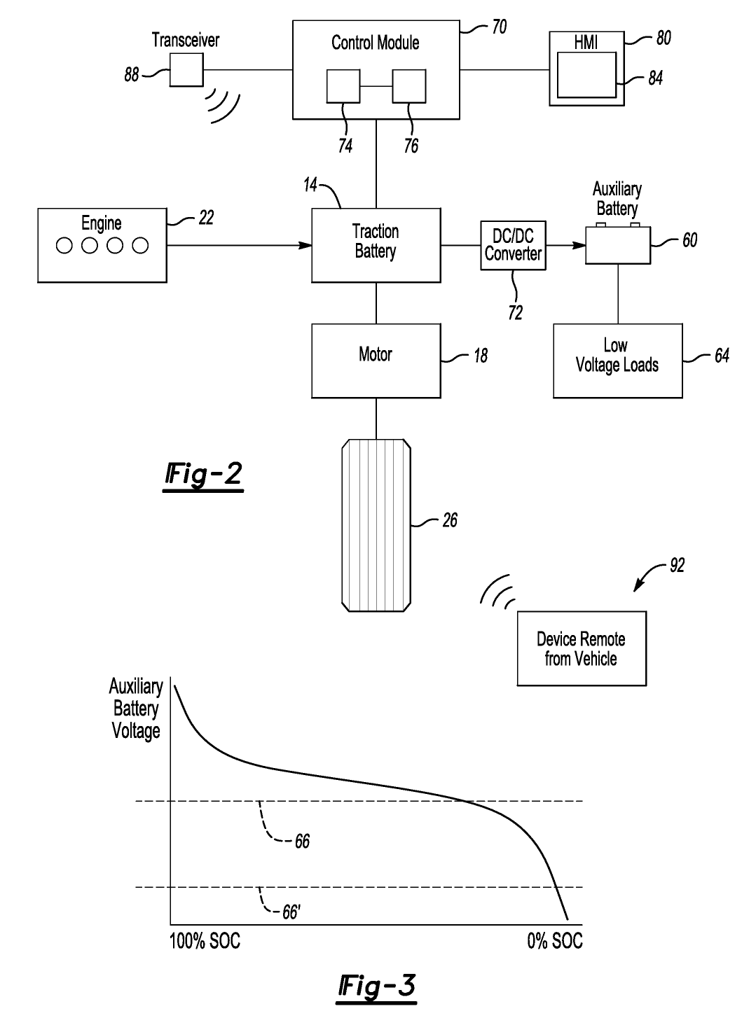

Referring now to FIG. 2 with continuing reference to FIG. 1, an exemplary vehicle having the powertrain 10 includes an auxiliary battery 60 that is used to power relatively low-voltage loads 64. Exemplary loads can include lighting loads, loads due to powering control modules, etc.

The auxiliary battery 60 and low-voltage loads are part of a low-voltage system of the vehicle whereas the traction battery 14 is part of a relatively high-voltage system of the vehicle. The auxiliary battery 60 can be a low-voltage battery (e.g., less than or equal to 12 volts). The traction battery 14 is a traction battery as the traction battery 14 powers propulsion of the vehicle. The auxiliary battery 60, in contrast to the traction battery 14, does not power propulsion of the vehicle.

The auxiliary battery 60 can power the low-voltage loads 64 even when the vehicle is keyed off and not operating, such as when the vehicle is stored, parked, or transported. A charge level of the auxiliary battery 60 can be reduced due to powering the low-voltage loads 64. If the vehicle is idle for an extended period, a charge level in the auxiliary battery 60 can be depleted such that the auxiliary battery 60 is unable to power the low-voltage loads 64. This could prevent, among other things, starting up the vehicle after the extended period.

The auxiliary battery 60 of the exemplary embodiment is considered healthy when a charge level of the auxiliary battery 60 is not below an auxiliary battery threshold 66, which is represented by a broken line in FIG. 3. The auxiliary battery threshold 66, in the exemplary embodiment, corresponds to a voltage of nominally 11.8V, and a SOC of about twenty percent. The auxiliary battery threshold 66 can be a threshold voltage, a threshold SOC, or some combination of these. The auxiliary battery 60, in some examples, may be considered extremely discharged at or below 15% SOC, and considered completely discharged at about 11.4V DC.

When the voltage of the auxiliary battery 60 is healthy, and thus at or above the auxiliary battery threshold 66, the auxiliary battery 60 is charged sufficiently to powering the low-voltage loads 64 for a set time period, say one day. When the voltage of the auxiliary battery 60 is below the auxiliary battery threshold 66, the auxiliary battery 60 is not charged sufficiently to continue powering the low-voltage loads 64 for the set time period. The auxiliary battery threshold 66 for a given auxiliary battery within a given vehicle could be determined by a person having skill in this art.

Referring again to FIG. 2, the vehicle of the exemplary embodiment further includes a control module 70 that, as will be described, can selectively initiate a charge of the auxiliary battery 60 from the traction battery 14. This can help to avoid the charge level of the auxiliary battery 60 dropping below the auxiliary battery threshold 66 where the auxiliary battery 60 is unable to appropriately power the low-voltage loads 64. The charge of the auxiliary battery 60 from the traction battery 14 can pass through a DC/DC converter 72.

The control module 70 can be part of an engine control module, a battery electric control module, etc. within the vehicle. The control module, in this example, includes a processor 74 operatively linked to a memory portion 76. The example processor 74 is programmed to execute a program stored in the memory portion 76. The program may be stored in the memory portion 76 as software code. The program stored in the memory portion 76 may include one or more additional or separate programs, each of which includes an ordered list of executable instructions for implementing logical functions.

The processor 74 can be a custom made or commercially available processor, a central processing unit (CPU), an auxiliary processor among several processors associated with the control module 70, a semiconductor based microprocessor (in the form of a microchip or chip set) or generally any device for executing software instructions.

The memory portion 76 can include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). Moreover, the memory may incorporate electronic, magnetic, optical, and/or other types of storage media. Note that the memory can also have a distributed architecture, where various components are situated remotely from one another, but can be accessed by the processor.

The control module 70, in the exemplary embodiment, is operably coupled to a human machine interface 80, which can include a touchscreen display 84 displayed within a passenger cabin of the vehicle. The touchscreen display 84 can display information transmitted from the control module 70. The touchscreen display 84 can provide an interface for a user to input information, such as commands, that are transmitted to the control module 70.

The control module 70, in the exemplary embodiment, is additionally operably coupled to a transceiver 88 configured to communicate with one or more remote devices 92 that can be remote from the vehicle. In another embodiment, the transceiver 88 is instead replaced with one or more receivers and one or more transmitters. The remote device 92 can be a key fob, a personal computer, a tablet, a cellular telephone, etc. The remote device 92 can wirelessly communicate with the control module 70 via the transceiver 88.

The remote device 92 can display information transmitted wirelessly from the control module 70, such as an alert. The remote device 92 can provide an interface for a user to input information, such as a command, that is transmitted wirelessly to the control module 70. The command can be in response to the alert.

The control module 70 is thus operably coupled to both the human machine interface 80 and, through the transceiver 88, the remote devices 92. In other exemplary embodiments, the control module 70 is operably coupled to the human machine interface 80 or the remote device 92, but not both.

In some exemplary embodiments, the control module 70 is instead, or additionally, operable coupled to other types of devices. The control module 70 can be configured to transmit an alert to, and receive a command from, the other types of devices. The other devices could provide, for example, an audible alert. The commands received from the other devices could be, for example, commands that are audibly initiated.

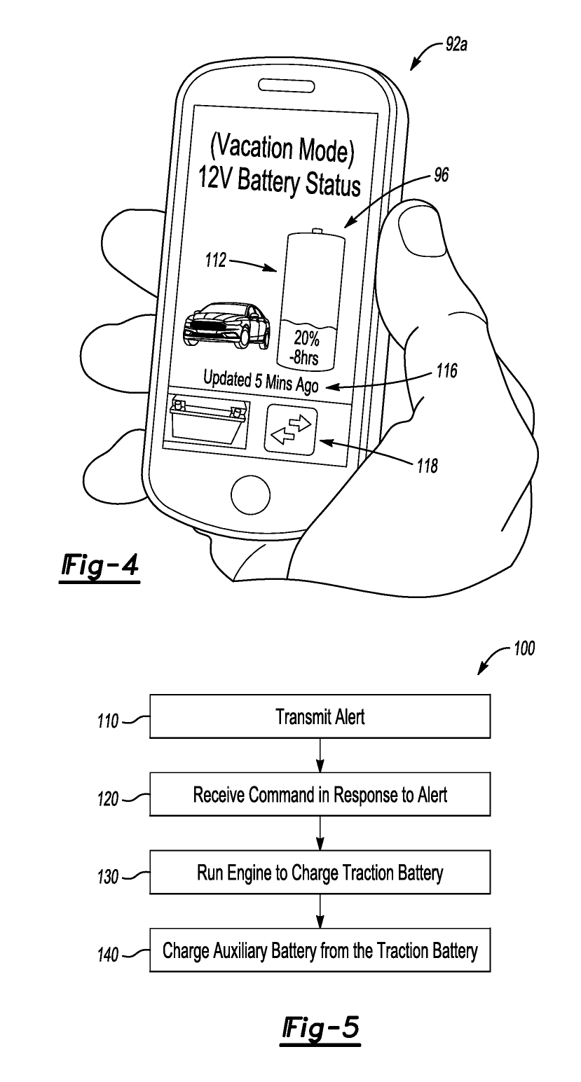

Referring now to FIG. 4 with continued reference to FIG. 2, a cellphone 92a is an example remote device 92. The cellphone 92a includes a display screen 96. Various icons and messages can be displayed on the display screen 96 to facilitate a user communicating with the control module 70 utilizing alerts and commands communicated between the transceiver 88 and the cellphone 92a.

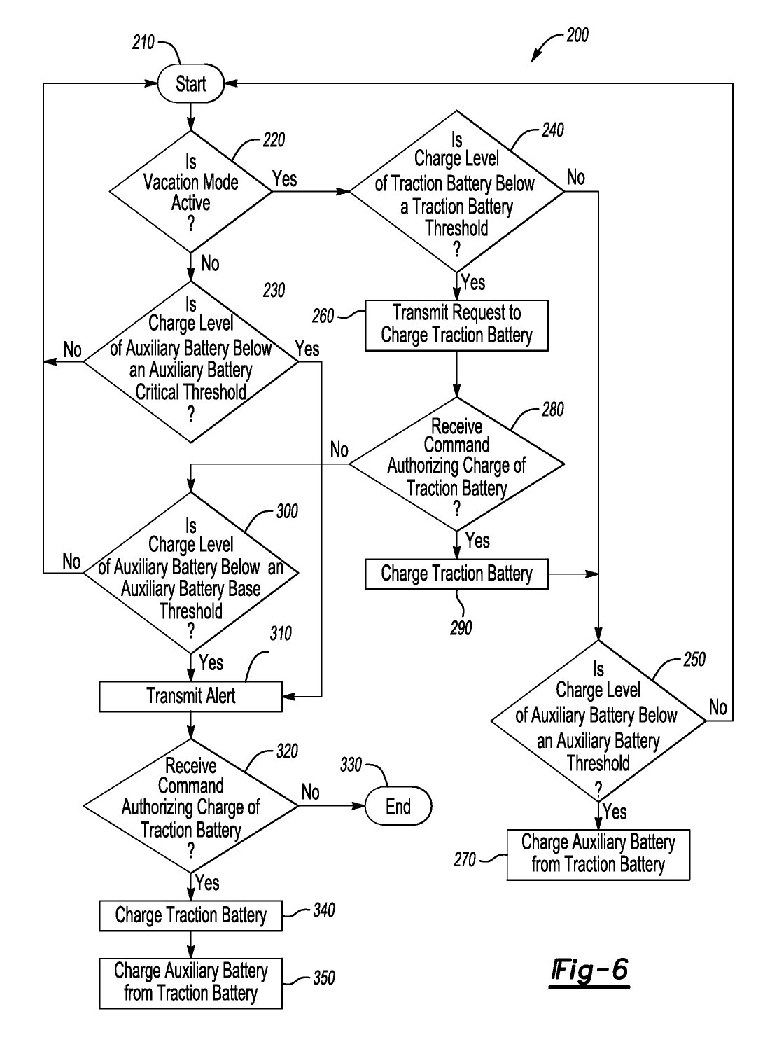

Referring to FIG. 5 with continuing reference to FIGS. 2 and 4, a method 100 can be utilized by the control module 70 to maintain the charge level of the auxiliary battery 60 to be at or above a threshold level. The method 100 is utilized by the control module 70, in the exemplary embodiment, when a user activates a vacation mode for the vehicle. When the vacation mode is not active, the control module 70 would not execute the method 100. The vacation mode could selectively activated from the remote devices 92, 92a, the human machine interface 80, or from some other device.

At a step 110, the method 100 transmits an alert from the transceiver 88 to the cellphone 92a. The alert includes displaying an icon 112 on the display screen that indicates a charge level of the auxiliary battery 60, as well as an amount of time. The charge level can be represented a current charge level of the auxiliary battery 60 (here 20%). The amount of time represents an estimate of how long the auxiliary battery 60 can, with the current charge level, continue to power the low-voltage loads. In this example, the amount of time remaining is 8 hours. The amount of time can be calculated based on the demands on the auxiliary battery 60 from the key-off loads and the current charge level of the auxiliary battery 60.

Instead of icons, the alert communicated to the cellphone 92a or other remote device could be a text message, email message, etc. The alert could have many forms for requesting authorization from the user.

The alert from the step 110 can further include displaying a last update time 116 corresponding to a time at which the charge level in the auxiliary battery 60 was measured. The alert transmitted at the step 110 further includes an energy transfer icon 118 on the display screen 96 of the cellphone 92a.

The control module 70 can be configured to send the alert in response to a charge level of the auxiliary battery 60 dropping below the auxiliary battery threshold 66, a charge level of the traction battery 14 dropping below the traction battery threshold level, or both. The auxiliary battery threshold 66 can be a low threshold, as shown, or a critically low threshold 66′ at which the auxiliary battery 60 may be unable to start the engine 22.

In response to the alert, the method 100 includes receiving a command at a step 120. In the exemplary embodiment, the user can cause a command to be sent from the cellphone 92a through the transceiver 88 to the control module 70. The user sends the command, in the exemplary embodiment, because the charge level of the auxiliary battery 60 is below the auxiliary battery threshold 66 of FIG. 3.

In the exemplary embodiment, the user touches the energy transfer icon 118 to initiate the command. Other examples could include initiating the command via a verbal instruction, or by some other technique.

The display of the energy transfer icon 118, the ability of the user to activate the energy transfer icon 118, or both, can depend on the charge level. For example, if the charge level is at or above the auxiliary battery threshold 66 of FIG. 3, the energy transfer icon 118 may not be displayed, or the user may not be able to send the command by touching the energy transfer icon 118.

The command authorizes a start of the engine 22, which may be a remote start of the engine 22. Remote start, for purposes of this disclosure, is a start of the engine 22 initiated by the user from a position that is remote from vehicle.

At a step 130, the control module 70, in response to the command, runs the engine 22 to charge the traction battery 14. A person having skill in this art and the benefit of this disclosure could understand how to run the engine 22 to charge the traction battery 14.

The method 100 then moves to a step 140 where the auxiliary battery 60 is charged from the traction battery 14. The charging of the auxiliary battery 60 from the traction battery 14 can include activating a high-voltage to low-voltage transfer of energy protocol through the DC/DC converter 72. A person having skill in this art and the benefit of this disclosure could understand how to charge the auxiliary battery 60 from the traction battery 14.

The engine 22 stops running when a charge level of the traction battery 60 has increased to a point at which the traction battery 60 can be used to raise a charge level of the auxiliary battery 60 to be at or above the auxiliary battery threshold 66. The step 140 can begin after the step 130 has concluded, or prior to concluding the step 130. In the exemplary embodiment, the charging of the auxiliary battery 60 at the step 140 continues well after shutting down the engine 22 to complete the step 130. Some of the charging of the auxiliary battery 60 by the traction battery 14 thus occurs without the engine 22 operating.

The auxiliary battery 60, in the example embodiment, has a charging acceptance rate of nominally 5-25 A, which is significantly lower than a charging acceptance rate of the traction battery 14. If the engine 22 were operated to directly charge the auxiliary battery 60, the time that the engine 22 would be required to operate would be much greater than the time in the method 100. Thus, utilizing the method 100 facilitates a charge of the auxiliary battery 60 with relatively short run time for the engine 22. The relatively short run time can, among other things, produce less exhaust gas and less noise than a longer run time.

Referring now to FIG. 6 with continued reference to FIGS. 2 and 3, another exemplary charging method 200 begins at a step 210.

The method 200 then moves to a step 220, which assesses whether or not a user-selected mode, here a vacation mode, for the vehicle has been activated. The vacation mode, when activated, authorizes the control module 70 to start the engine 22 to charge the traction battery 14, and to then charge the auxiliary battery 60 with the traction battery 14.

The user could activate and deactivate the vacation mode by interfacing with the touchscreen display 84 of the human machine interface 80 within the vehicle. The user could instead, or additionally, activate and deactivate the vacation mode utilizing the remove device 92.

If the vacation mode is not active at the step 220, the method 200 moves to a step 230. If the vacation mode is active at the step 220, the method 200 progresses to a step 240.

At the step 240, the control module 70 compares the charge level of the traction battery 14 to a traction battery threshold. If the traction battery 14 is at or above the traction battery threshold, the traction battery 14 has charge sufficient to charge the auxiliary battery 60. In some examples, the vehicle is an FHEV and the traction battery threshold for the traction battery 14 is 50 watt-hours. In other examples, the traction battery threshold could be at least 300 watt-hours for an FHEV, or many kWh for a plug-in vehicle, such as a PHEV, or a Battery Electric Vehicle.

The step 240 could involve a comparison of the charge level of the auxiliary battery 60 to the auxiliary battery threshold 66. This is because the traction battery threshold level, in some examples, can vary based on a difference between the charge level of the auxiliary battery 60 and the auxiliary battery threshold 66. For example, a large variation between the charge level of the auxiliary battery 60 and the auxiliary battery threshold 66 would require the traction battery 14 to have more charge in order to raise the charge level of the auxiliary battery 60 to the auxiliary battery threshold 66. The traction battery threshold level would thus be higher for a relatively large variation between the charge level of the auxiliary battery 60 and the auxiliary battery threshold 66 than a relatively small variation.

If, at the step 240, the charge level in the traction battery 14 is not below the traction battery threshold level, the method 200 moves to a step 250. If, at the step 240, the charge level in the traction battery 14 is below a traction battery threshold level, the method 200 moves from the step 240 to the step 260.

At the step 250, the method 200 assesses whether the charge level of the auxiliary battery 60 is below the auxiliary battery threshold 66 for the auxiliary battery 60. If, at the step 250, the charge level of the auxiliary battery 60 is not below the auxiliary battery threshold 66, the method 200 returns to the step 210. If, at the step 250, the charge level of the auxiliary battery 60 is below the auxiliary battery threshold 66, the method 200 moves to the step 270 where the auxiliary battery 60 is charged from the traction battery 14. Charging the auxiliary battery 60 from the traction battery 14 raises the charge level of the auxiliary battery 60 to be at or above the auxiliary battery threshold 66. Charging the auxiliary battery at the step 270 to meet or exceed the auxiliary battery threshold 66 ensures that the auxiliary battery 60 can power the low-voltage loads 64.

The method 200 does not, in this embodiment, send an alert to the user to initiate the charge of the auxiliary battery 60 because the charge of the auxiliary battery 60 can occur without starting the engine 22. In another embodiment, the method 200 communicates an alert to the user requesting a command to authorize the charge of the auxiliary battery 60 from the traction battery 14 even though starting the engine 22 is not required. If such an authorization is received, the method 200 moves to the step 270. If such an authorization is not received, the method 200 returns to the step 210.

At the step 260, the method 200 sends a request to charge the traction battery 14. The request can be a request to charge the traction battery 14 when an ignition for the vehicle is keyed-off. The request in the step 260 can be set just as the user is about to leave the vehicle at the conclusion of a drive cycle, such as the vehicle gearshift is moved to Park. The request at the step 260 can be a message displayed on the instrument cluster or other HMI display. The message can request that the user authorizes the engine 22 to operate for a time, say 5 minutes, to charge the traction battery 14 even though the vehicle is keyed off. The request could include asking the user to confirm whether or not the vehicle is in an enclosed space where engine operation may not be allowed.

At a step 280, a yes or no response from the user is received. If yes, the method moves to the step 290 where the vehicle will continue to operate for up to 5 minutes after the driver leaves the vehicle to charge the traction battery. After the charging the step 290 is complete, the method moves to the step 250. If the response at the step 280 is no, the method 200 moves to a step 300.

At the step 250, the method 200 assesses whether the charge level of the auxiliary battery 60 is below the auxiliary battery threshold 66 for the auxiliary battery 60. If, at the step 250, the charge level of the auxiliary battery 60 is not below the auxiliary battery threshold 66, the method 200 returns to the step 210.

If, at the step 300, the charge level of the auxiliary battery 60 is below the auxiliary battery base threshold 66, the method 200 moves to a step 310 where an alert is transmitted to a user of the vehicle.

The method 200 also moves to the step 310 if, at the step 230, the charge level of the auxiliary battery 60 were determined to be below a critical threshold. Critically low could be, for example, a level unsuitable for starting the vehicle. If, at the step 230, the charge level is not critically low, the method 200 returns to the start 210. The step 230, even though the vacation mode is inactive, can still monitor the auxiliary battery for a critically low SOC threshold.

At the step 310, the alert can be an alert sent to the remote device 92 when the remote device 92 is remote from the vehicle. Another exemplary embodiment for the alert could include displaying a pop-up message on the touchscreen display 84 of the human machine interface 80 within a passenger compartment of the vehicle, similar to the message displayed in connection with steps 240 and 260. Such an alert connected to a portion the vehicle, rather than a device remove from the vehicle, is considered an in-vehicle alert.

In response to the alert transmitted at the step 310, the control module can receive a command as described in connection with the cell phone 92a of FIG. 4. The command could be initiated in a number of ways. If the alert is communicated via the human machine interface 80, the command in response to the alert could be, for example, initiated by the driver interacting with a virtual button on the touchscreen display 84 of the human machine interface 80. The alert can include a request to charge the traction battery 14 by operating the engine 22. The alert could include asking the user to confirm whether or not the vehicle is in an enclosed space where engine operation may not be allowed.

At a step 320, the method 200 assesses whether a command authorizing a charge of the traction battery 14 has been received. If no authorizing command is received at a step 320 in response to the alert from the step 310, the method 200 can ends at a step 330. The method 200 may end at the step 330 in response to the user, in response to the step 320, commanding no charging. If the user states no to charging and the method ends at step 330, the method 200 may send no further alerts, and may take no other actions, until the method 200 begins again at a subsequent ignition cycle. The method 200 could also begin again in response to a command from the user, for example, that authorizes the method 200 to begin again.

If a command is received at a step 320 authorizing further operation of the engine 22, method moves to the step 340 where the engine 22 turns on (or remains on) and begins to charge the traction battery 14. The running of the engine 22 charges the traction battery 14 to meet or exceed the traction battery threshold.

The method 200 can move from the step 340 to the step 350 where the traction battery 14 charges the auxiliary battery 60.

Notably, for some embodiments of the method 200, prompting the user to enter the vacation mode and the user then authorizing the vehicle to enter the vacation mode could be considered a transmission of an alert and the receiving of a command in response to the alert. In such embodiments, the alert transmitted at the step 310 and the command received at the step 320 could be omitted. In such examples, the user is considered to have already provided a command authorizing the start of the engine 22 to charge the traction battery 14 by the user choosing to enter the vacation mode.

Features of the disclosed examples include assemblies and methods to provide a preemptive or on-demand charging of a traction battery by operating an engine, and the charging of an auxiliary battery from the traction battery. The system can alert a user of, among other things, a charge level of the auxiliary battery.

Sizing of the auxiliary battery is driven by, among other things, the ability of the auxiliary battery to sustain vehicle key-off loads for extended periods of time when the vehicle is stored, parked, or both. The extended periods of time are from 40 to 70 days in some examples.

The preemptive or on-demand charging can, in some examples, permit a size of the auxiliary battery to be reduced. For example, the auxiliary battery can be reduced from a nominal 50-70 A-H capacity to less than 40 A-H since the auxiliary battery can be intermittently recharged by the traction battery. This can provide weight and cost savings. The vehicle thus can remain idle when, for example, being shipped from a plant to a dealership, without the auxiliary battery ever depleting below a level sufficient to power the key-off loads.

The smaller auxiliary battery can provide more design and packaging flexibility. A smaller auxiliary battery could be, for example, positioned close to the DC/DC converter of the vehicle, which can, among other things, reduce an amount of wiring required to electrically couple the auxiliary battery to the DC/DC converter.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

What is claimed is:

1. A charging method, comprising:
transmitting an alert and receiving a command from a user in response to the alert; and
in response to the command, both running an engine to charge a traction battery and charging an auxiliary battery from the traction battery.

2. The charging method of claim 1, further comprising transmitting the alert in response to a charge level of the traction battery being below a threshold level.

3. The charging method of claim 2, wherein the threshold level is a charge level sufficient to charge the auxiliary battery.

4. The charging method of claim 1, further comprising transmitting the alert in response to a charge level of the auxiliary battery being below a threshold level.

5. The charging method of claim 1, further comprising a user-selected mode of the vehicle, the transmitting occurring when the user-selected mode is activated, the transmitting blocked from occurring when the user-selected mode is deactivated.

6. The charging method of claim 1, wherein the alert is sent to a device remote from a vehicle having the engine.

7. The charging method of claim 6, wherein the command is received from the device remote from the vehicle.

8. The charging method of claim 1, wherein the command is received from a device remote from a vehicle having the engine.

9. The charging method of claim 1, wherein the alert is an in-vehicle alert.

10. The charging method of claim 9, wherein the in-vehicle alert is a visual alert displayed within the vehicle.

11. The charging method of claim 9, wherein the alert is transmitted at a completion of a drive cycle before a user has exited a passenger cabin of the vehicle.

12. The charging method of claim 1, wherein at least some of the charging of the auxiliary battery occurs while running the engine to charge the traction battery.

13. The charging method of claim 1, further comprising, after running the engine to charge the traction battery, stopping the engine, and then starting the charging of the auxiliary battery from the traction battery.

14. An electrified vehicle assembly, comprising:
a traction battery;
an auxiliary battery;
an engine; and
a controller configured to cause the engine to run to charge the traction battery in response to a command received from a user, and further configured to cause the traction battery to charge the auxiliary battery.

15. The electrified vehicle assembly of claim 14, wherein the controller is configured cause the traction battery to charge the auxiliary battery after stopping the engine.

16. The electrified vehicle assembly of claim 14, wherein the controller is configured to initiate a transmission of an alert in response to a charge level of the auxiliary battery falling below an auxiliary battery threshold charge level, the command received in response to the alert.

17. The electrified vehicle assembly of claim 14, wherein the controller is configured to initiate a transmission of an alert in response to a charge level of the traction battery falling below a traction battery threshold charge, the command received in response to the alert.

18. The electrified vehicle assembly of claim 14, wherein the command is received from a device remote from the vehicle.

19. The electrified vehicle assembly of claim 14, wherein the command is received from an interface within a passenger cabin of the vehicle at the conclusion of a drive cycle.
